(19) United States
(12) Patent Application Publication
(10) Pub. No.: US 2005/0050449 A1
(43) Pub. Date: Mar. 3, 2005

(54) Web presentation architecture that supports page navigation management

(76) Inventors: Brian James DeHamer, San Diego, CA (US); Sankar Ram Sundaresan, San Jose, CA (US)

Correspondence Address: HEWLETT-PACKARD COMPANY;Intellectual Property Administration, P.O. Box 272400, Fort Collins, CO, 50527-2400, US

(21) Appl. No.: 10/652,988

(22) Filed: Aug. 29, 2003

(51) Int. Cl. G06F 17/00

(52) U.S. Cl. 715/501.1

(57) ABSTRACT

The disclosed embodiments relate to a system and method for creating web applications. The system comprises a controller generator that is adapted to provide a web application with a controller that receives requests for data from users and responds to the requests by obtaining requested data. The system also comprises a navigation manager generator that is adapted to recall a user request upon completion of a prerequisite.

### BACKGROUND OF THE RELATED ART

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Presentations and applications are continuously developing on the World Wide Web (the “Web), which has undergone an explosive growth in recent years. Early Web applications largely involved simple presentations of data, such as a corporate website displaying personnel information, contact information, and other general business information. However, the current trend of Web applications involves a dynamic exchange of data, complicated logic and functionality, animated graphics, and communication with various remote services. As a result, the content and functionality of Web applications are becoming increasingly complex and difficult to manage.

Certain Web applications provide one or more special pages that may function as a gateway to other pages. Examples of these gateway pages, which may be referred to as prerequisites, may include user login and authentication pages. If a user attempts to access one of the other pages, then the Web application may redirect the user to one of these special pages or prerequisites. Unfortunately, the Web application does not track the originally requested page and, thus, the user is left at the special page.

### BRIEF DESCRIPTION OF THE DRAWINGS

Advantages of one or more disclosed embodiments may become apparent upon reading the following detailed description and upon reference to the drawings in which:

FIG. 1 is a block diagram that illustrates a model-view-controller (“MVC”) application architecture, which may be created using embodiments of the present invention may be employed;

FIG. 2 is a block diagram that illustrates a web presentation architecture in accordance with embodiments of the present invention;

FIG. 3 is a block diagram that illustrates the operation of a web application program created using a web presentation architecture in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

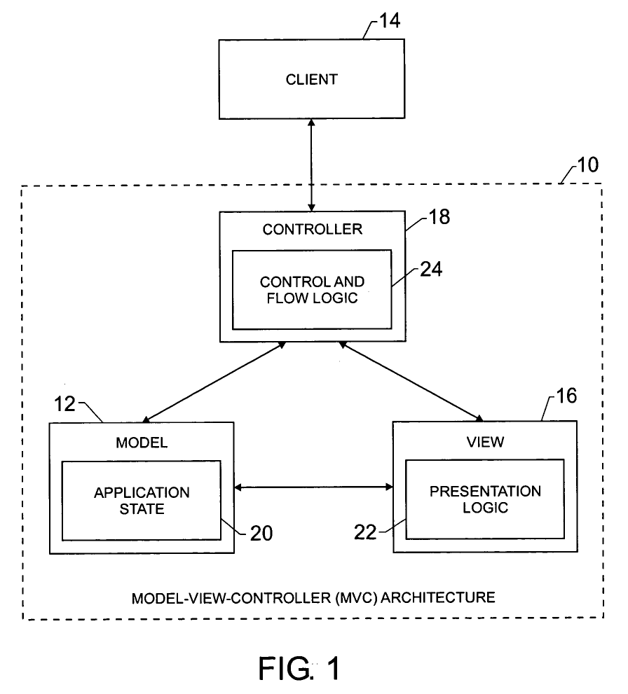

FIG. 1 is a block diagram that illustrates a model-view-controller (“MVC”) application architecture, which may be created using embodiments of the present invention. As illustrated, the MVC architecture 10 separates the application object or model 12 from a view 16, which is responsible for receiving input and presenting output to a client 14. In a web application context, the client 14 may comprise a browser. The model object and the view are also separated from the control functions of the application, which are represented in FIG. 1 as a controller 18. In general, the model 12 comprises an application state 20, the view 16 comprises presentation logic 22, and the controller 18 comprises control and flow logic 24. By separating these three MVC objects 12, 16, and 18 with abstract boundaries, the MVC architecture 10 provides flexibility, organization, performance, efficiency, and reuse of data, presentation styles, and logic.

The WPA 100 may be configured with a variety of object-oriented programming languages, such as Java by Sun Microsystems, Inc., Santa Clara, Calif. An object is generally any item that can be individually selected and manipulated. In object-oriented programming, an object may comprise a self-contained entity having data and procedures to manipulate the data. For example, a Java-based system may utilize a variety of JavaBeans, servlets, Java Server Pages, and so forth. JavaBeans are independent, reusable software modules. In general, JavaBeans support introspection (a builder tool can analyze how a JavaBean works), customization (developers can customize the appearance and behavior of a JavaBean), events (JavaBeans can communicate), properties (developers can customize and program with JavaBeans), and persistence (customized JavaBeans can be stored and reused). JSPs provide dynamic scripting capabilities that work in tandem with HTML code, separating the page logic from the static elements. According to certain embodiments, the WPA 100 may be designed according to the Java 2 Platform Enterprise Edition (J2EE), which is a platform-independent, Java-centric environment for developing, building and deploying multi-tiered Web-based enterprise applications online.

The model 12 comprises a definitional framework representing the application state 20. For example, in a web-based application, the model 12 may comprise a JavaBean object or other suitable means for representing the application state 20. Regardless of the application or type of object, an exemplary model 12 may comprise specific data and expertise or ability (methods) to get and set the data (by the caller). The model 12 generally focuses on the intrinsic nature of the data and expertise, rather than the extrinsic views and extrinsic actions or business logic to manipulate the data. However, depending on the particular application, the model 12 may or may not contain the business logic along with the application state. For example, a large application having an application tier may place the business logic in the application tier rather than the model objects 12 of the web application, while a small application may simply place the business logic in the model objects 12 of the web application.

As noted above, the view and controller objects 16 and 18 separately address these extrinsic views and actions or business logic. For example, the model 12 may represent data relating to a person (e.g., an address, a birth date, phone number, etc.), yet the model 12 is independent of extrinsic formats (e.g., a date format) for displaying the personal data or extrinsic actions for manipulating the personal data (e.g., changing the address or phone number). Similarly, the model 12 may represent data and expertise to track time (e.g., a clock), yet the model 12 is independent of specific formats for viewing the clock (e.g., analog or digital clock) or specific actions for manipulating the clock (e.g., setting a different time zone). These extrinsic formats and extrinsic actions are simply not relevant to the intrinsic behavior of the model clock object. One slight exception relates to graphical model objects, which inherently represent visually perceptible data. If the model 12 represents a particular graphical object, then the model 12 has expertise to draw itself while remaining independent of extrinsic formats for displaying the graphical object or extrinsic actions for creating or manipulating the graphical object.

The view 16 generally manages the visually perceptible properties and display of data, which may be static or dynamic data derived in whole or in part from one or more model objects 12. As noted above, the presentation logic 22 functions to obtain data from the model 12, format the data for the particular application, and display the formatted data to the client 14. For example, in a web-based application, the view 16 may comprise a Java Server Page (JSP page) or an HTML page having presentation logic 22 to obtain, organize, format, and display static and/or dynamic data. Standard or custom action tags (e.g., jsp:useJavaBean) may function to retrieve data dynamically from one or more model objects 12 and insert model data within the JSP pages. In this manner, the MVC architecture 10 may facilitate multiple different views 16 of the same data and/or different combinations of data stored by one or more model objects 12.

The controller 18 functions as an intermediary between the client 14 and the model object 12 and view 16 of the application. For example, the controller 18 can manage access by the view 16 to the model 12 and, also, manage notifications and changes of data among objects of the view 16 and objects of the model 12. The control and flow logic 24 of the controller 18 also may be subdivided into model-controllers and view-controllers to address and respond to various control issues of the model 12 and the view 16, respectively. Accordingly, the model-controllers manage the models 12 and communicate with view-controllers, while the view-controllers manage the views 16 and communicate with the model-controllers. Subdivided or not, the controllers 18 ensure communication and consistency between the model 12 and view 16 and the client 14.

In operation, the control and flow logic 24 of the controller 18 generally receives requests from the client 14, interprets the client requests, identifies the appropriate logic function or action for the client requests, and delegates responsibility of the logic function or action. Requests may be received from the client via a number of protocols, such as Hyper Text Transfer Protocol (“HTTP”) or HTTP with Secure Sockets Layer (“HTTPS”). Depending on the particular scenario, the appropriate logic function or action of the controller 18 may include direct or indirect interaction with the view 16 and/or one or more model objects 12. For example, if the appropriate action involves alteration of extrinsic properties of data (e.g. reformatting data in the view 16), then the controller 18 may directly interact with the view 16 without the model 12. Alternatively, if the appropriate action involves alteration of intrinsic properties of data (e.g., values of data in the model 12), then the controller 18 may act to update the corresponding data in the model 12 and display the data in the view 16.

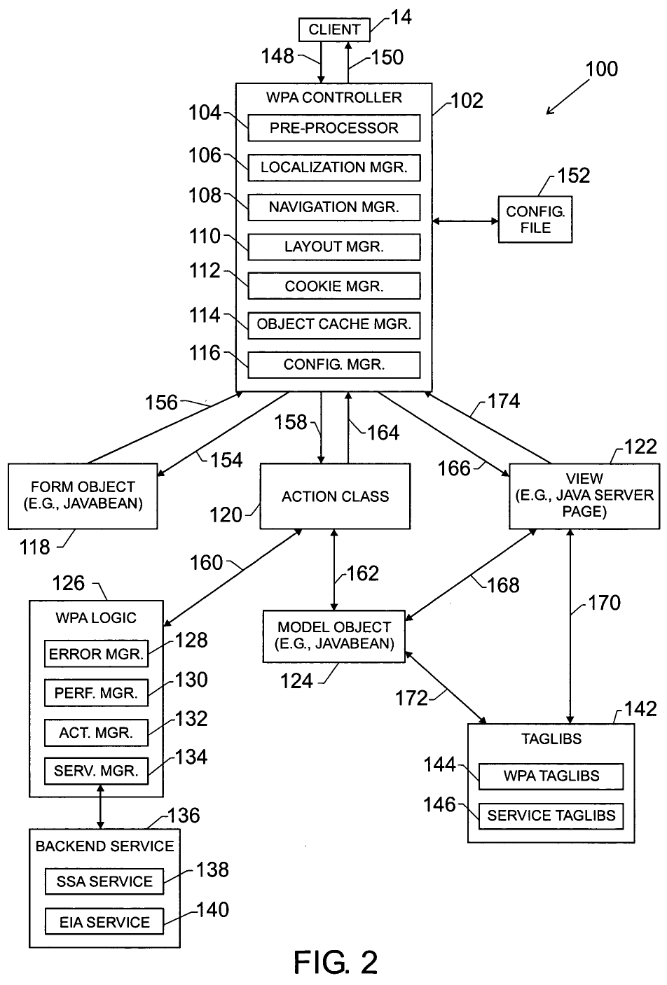

FIG. 2 is a block diagram illustrating an exemplary web presentation architecture (“WPA”) 100 in accordance with certain embodiments of the present invention. The illustrated WPA 100, which may be adapted to execute on a processor-based device such as a computer system or the like, has certain core features of the MVC computing strategy, and various additional features and enhancements to improve its architectural operation and performance. For example, the illustrated WPA 100 separates the model, the view, and the controller as with the traditional MVC architecture, yet the WPA 100 provides additional functionality to promote modularity, flexibility, and efficiency.

As illustrated, the WPA 100 comprises a WPA controller 102 having a preprocessor 104, a localization manager 106, the navigation manager 108, a layout manager 110, a cookie manager 112, and object cache manager 114, and a configurator or configuration manager 116. The WPA controller 102 functions as an intermediary between the client 14, form objects 118, action classes 120, and views 122. In turn, the action classes 120 act as intermediaries for creating/manipulating model objects 124 and executing WPA logic 126, such as an error manager 128, a performance manager 130, and activity manager 132, and a backend service manager 134. As described below, the backend service manager 134 functions to interface backend services 136. Once created, the model objects 124 can supply data to the view 122, which can also call various tag libraries 142 such as WPA tag libraries 144 and service tag libraries 146.

In operation, the client 14 sends a request 148 to the WPA 100 for processing and transmission of a suitable response 150 back to the client 14. For example, the request 148 may comprise a data query, data entry, data modification, page navigation, or any other desired transaction. As illustrated, the WPA 100 intakes the request 148 at the WPA controller 102, which is responsible for various control and flow logic among the various model-view-controller divisions of the WPA 100. For example, the WPA controller 102 can be implemented as a Servlet, such as a HyperText Transfer Protocol (“HTTP”) Servlet, which extends the ActionServlet class of Struts (an application framework promulgated by the Jakarta Project of the Apache Software Foundation). As illustrated, the WPA controller 102 invokes a configuration resource file 152, such as struts-config.xml, which provides mapping information for form classes, action classes, and other objects. Based on the particular request 148, the WPA controller 102 locates the appropriate action class and, also, the appropriate form class if the request 148 contains form data (e.g., client data input). For example, the WPA controller 102 may lookup a desired WPA Action Form and/or WPA Action Class, which function as interfaces to WPA Form Objects and WPA Action Objects.

If the client entered data, then the WPA controller 102 creates and populates the appropriate form object 118 as indicated by arrow 154. The form object 118 may comprise any suitable data objects type, such as a JavaBean, which functions to store the client entered data transmitted via the request 148. The WPA controller 102 then regains control as indicated by arrow 156.

If the client did not enter data, or upon creation and population of the appropriate form object 118, then the WPA controller 102 invokes the action class 120 to execute various logic suitable to the request 148 as indicated by arrow 158. For example, the action class 120 may call and execute various business logic or WPA logic 126, as indicated by arrow 160 and discussed in further detail below. The action class 120 then creates or interacts with the model object 124 as indicated by arrow 162. The model object 124 may comprise any suitable data object type, such as a JavaBean, which functions to maintain the application state of certain data. One example of the model object 124 is a shopping cart JavaBean, which stores various user data and e-commerce items selected by the client. However, a wide variety of model objects 124 are within the scope of the WPA 100. After executing the desired logic, the action class 120 forwards control back to the WPA controller 102 as indicated by arrow 164, which may be referred to as an “action forward.” This action forward 164 generally involves transmitting the path or location of the server-side page, e.g., the JSP.

As indicated by arrow 166, the WPA controller 12 then invokes the foregoing server-side page as the view 122. Accordingly, the view 122 interprets its links or tags to retrieve data from the model object 124 as indicated by arrow 168. Although a single model object 124 is illustrated, the view 122 may retrieve data from a wide variety of model objects. In addition, the view 122 interprets any special logic links or tags to invoke tag libraries 142 as indicated by arrow 170. For example, the WPA tag libraries 144 and the service tag libraries 146 can include various custom or standard logic tag libraries, such as <html>, <logic>, <template>developed as part of the Apache Jakarta Project or the like. Accordingly, the tag libraries 142 further separate the logic from the content of the view 122, thereby facilitating flexibility and modularity. In certain cases, the tag libraries 142 also may interact with the model object 124 as indicated by arrow 172. For example, a special tag may execute logic to retrieve data from the model object 124 and manipulate the retrieved data for use by the view 122. After interacting with the model object 124 and the appropriate tag libraries 142, the WPA 100 executes the view 122 (e.g., JSP) to create a client-side page for the client 14 as indicated by arrow 174. For example, the client-side page may comprise an XML or HTML formatted page, which the WPA controller 102 returns to the client 14 via the response 150.

As discussed above, the WPA 100 comprises a variety of unique logic and functional components, such as control components 104 through 116 and logic 128 through 134, to enhance the performance of the overall architecture and specific features 100. These components and logic generally operate on the server-side of the WPA 100, yet there are certain performance improvements that may be apparent on the client-side. These various components, while illustrated as subcomponents of the controller 102 or types of logic 126, may be standalone or integrated with various other portions of the WPA 100. Accordingly, the illustrated organization of these components is simply one exemplary embodiment of the WPA 100, while other organizational embodiments are within the scope of the present technique.

Turning to the subcomponents of the WPA controller 102, the preprocessor 104 provides preprocessing of requests by configuring portal specific functions to execute for each incoming request registered to the specific portal. The preprocessor 104 identifies the appropriate portal specific functions according to a preset mapping, e.g., a portal-to-function mapping in the configuration file 152. Upon completion, the preprocessor 104 can redirect to a remote Uniform Resource Identifier (URI), forward to a local URI, or return and continue with the normal processing of the request 148 by the WPA controller 102. One example of such a preprocessing function is a locale, which is generally comprised of language preferences, location, and so forth. The preprocessor 104 can preprocess local logic corresponding to a particular portal, thereby presetting language preferences for subsequent pages in a particular application.

The locale information is also used by the localization manager 106, which functions to render localized versions of entire static pages rather than breaking up the static page into many message strings or keys. Instead of using a single page for all languages and obtaining localized strings from other sources at run time, the localization manager 106 simply looks up a localized page according to a locale identifier according to a preset mapping, e.g., a locale-to-localized page mapping in the configuration file 152.

The navigation manager 108 generally functions to save a users intended destination and subsequently recall that information to redirect the user back to the intended destination. For example, if the user intends to navigate from point A to point B and point B queries for certain logic at point C (e.g., a user login and password), then the navigation manager 108 saves the address of point B, proceeds to the requested logic at point C, and subsequently redirects the user back to point B.

The layout manager 110 enables a portal to separate the context logic functioning to render the common context from the content logic functioning to render the content portion of the page. The common context (e.g., C-Frame) may include a top portion or header, a bottom portion or footer, and a side portion or sidebar, which collectively provides the common look and feel and navigational context of the page.

The cookie manager 112 functions to handle multiple cookie requests and to set the cookie value based on the most recent cookie request before committing a response. For example, in scenarios where multiple action classes attempt to set a particular cookie value, the cookie manager 112 caches the various cookie requests and defers setting the cookie value until response time. In this manner, the cookie manager 112 ensures that different action classes do not erase cookie values set by one another and, also, that only one cookie can exist with a particular name, domain, and path.

The object cache manager 114 enables applications to create customized in-memory cache for storing objects having data originating from backend data stores, such as databases or service based frameworks (e.g., Web Services Description Language “WSDL”). The in-memory cache may be customized according to a variety of criteria, such as cache size, cache scope, cache replacement policy, and time to expire cache objects. In operation, the object cache manager 114 improves performance by reducing processing time associated with the data from the backend data stores. Instead of retrieving the data from the backend data stores for each individual request 148, the object cache manager 114 caches the retrieved data for subsequent use in processing later requests.

The configurator or configuration manager 116 functions to load repeatedly used information, such as an error code table, into memory at startup time of a particular web application. The configuration manager 116 retains this information in memory for the duration of a session, thereby improving performance by eliminating the need to load the information each time the server receives a request.

Turning to the WPA logic 126, the error handler or manager 128 functions to track or chain errors occurring in series, catalog errors messages based on error codes, and displaying error messages using an error catalog. The error catalog of the error manager 128 may enable the use of generic error pages, which the error manager 128 populates with the appropriate error message at run time according to the error catalog.

The WPA logic function 126 may comprise performance and activity managers 130 and 132, which may facilitate tracking and logging of various information associated with a particular transaction or request. The error manager 128 may also be adapted to participate in tracking and logging operations as well.

The service manager 134 of the WPA logic 126 functions as an interface between the WPA 100 and various backend services 136. In operation, the service manager 134 communicates with the desired backend service 136 according to the client request 148, parses a response from the backend service 136 to obtain the appropriate data, and pass it to the appropriate object of WPA 100.

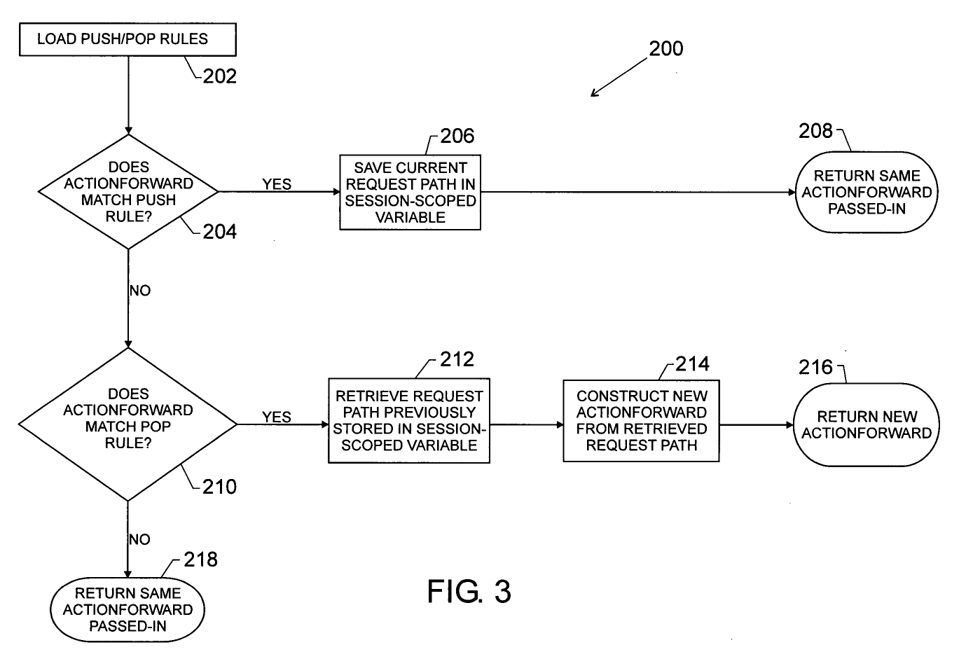

Turning now to FIG. 3, an exemplary navigation control process 200 of the navigation manager 108 is described according to certain embodiments of the present technique. As noted above with reference to FIG. 2, the navigation manager 108 may employ a variety of navigational control logic, such as path tracking logic, to track and ensure the user's desired destinations throughout a particular Web application. For example, the navigation manager 108 can provide storage logic to save the users intended destination and recall logic to recall and redirect the user to that intended destination. This is particularly advantageous in scenarios where the user is redirected to a special page or prerequisite rather than the intended destination. For example, the special page or prerequisite may comprise a form, a user login request, a user password request, an authentication page, an identification of user access rights, or other such prerequisites. Upon completion of a form or logic at the special page, the navigation manager 108 recalls and forwards the user to the originally intended destination.

In the illustrated embodiment, the navigation manager 108 is configured through one or more configuration files, such as navigation.xml. The configuration file, e.g., navigation.xml, can employ two types of logic or rules, such as push rules and pop rules. The push rules arise when the user is initially directed to a special page rather than the user's intended destination, while the pop rules arise after the user successfully completes the special page. The push and pop rules may have the following formats:

(1) Push Rule: <rule portal=“portal_name” path=“view_path” action=“push”/>
(2) Pop Rule: <rule portal=“portal_name” path=“view_path” action=“pop”/>

As set forth above, the push rule commands the navigation manager 108 to save the current request URL (e.g., request 148) if the specified view path matches the path in the action forward 164 and the current portal context matches the one specified in the rule. The navigation manager 108 can save the current request URL in any suitable location, such as a session object for the current user. In addition to saving the current request URL, the push rule of the navigation manager 108 can provide other attributes, such as a “target” attribute. An exemplary target attribute is a target path, which functions to instruct the navigation manager 108 to return a new action forward to the WPA controller 102. The value of the target attribute can then be used as the path of the new action forward.

If the navigation manager 108 encounters a pop rule having path and portal attributes matching the path in the action forward 164 and the current portal context, then the navigation manager 108 retrieves the saved URL from the current user's session object. The navigation manager 108 then creates and returns a new action forward to the WPA controller 102 using the retrieved URL.

An example of the navigation configuration file, e.g., navigation.xml, is set forth below:

```
<nav-manager-rules>
  <rule>
    portal=“itrc”
    path=“/ciss/liginRequired.jsp”
    action=“push”
    target=“/ciss/doLogin.do”/>
  <rule
    prtal=“itrc”
    path=“/ciss/loginSuccess.jsp”
    action=“pop”/>
</nav-manager-rules>
```

In the foregoing example, the navigation manager 108 uses the push rule to save the current request URL if it encounters an action forward 164 containing the path “/ciss/Requiredjsp” and the current portal context matches “itrc.” In addition, the navigation manager 108 uses the push rule to create and return to the WPA controller 102 a new action forward containing the path “/ciss/doLogin.do.” Using the pop rule, if the navigation manager 108 encounters an action forward containing the path “/ciss/doSuccessjsp”and the portal context matches “itrc,” then the navigation manager 108 functions to look up the saved URL in the current user's session object and create a new action forward based on the saved URL. In this manner, the push rule of the navigation manager 108 tracks the user's intended destination (e.g., current request URL) when a prerequisite (e.g., user login and authentication) for its access exists. After successfull completion of the prerequisite, the pop rule of the navigation manager 108 recalls and forwards the user to the user's originally intended destination. Although specific examples are provided above, the navigation configuration file may contain any number of push/pop rules.

As illustrated in FIG. 3, the navigation control process 200 of the navigation manager 108 begins by loading various push and pop rules as described above (block 202). In operation, the navigation control process 200 queries whether an action forward 164 for a particular request 148 matches the push rule (block 204). If the action forward 164 matches the push rule, then the navigation control process 200 proceeds to save the current request path 148 in a session-scoped variable (block 206). The navigation control process 200 then proceeds to return the same action forward 164 passed-in to the WPA controller 102 (block 208). As described in detail above, the foregoing process 204 through 208 ensures that the originally intended destination (e.g., the request 148) is stored for subsequent retrieval and execution by the WPA controller 102.

If the action forward 164 does not match the push rule at query block 204, then the navigation control process 200 proceeds to query whether the action forward 164 matches the pop rule (block 210). If the action forward 164 matches the pop rule, then the navigation control process 200 proceeds to retrieve the originally intended destination (e.g., the request 148) previously stored in the session-scoped variable (block 212). The navigation control process 200 then constructs a new action forward using the retrieved request 148 (block 214). The new action forward is then returned to the WPA controller 102 for processing and redirection of the user back to the originally intended destination, e.g., the request 148 (block 216). If the action forward 164 fails to match both push and pop rules, then the navigation control process 200 proceeds to return the same action forward 164 passed-in to the WPA controller 102 (block 218). As described in detail above, the foregoing process 210 through 216 ensures that the originally intended destination (e.g., the request 148) is recalled and processed by the VVPA controller 102 following redirection to and completion of a special page, such as a login page.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A system for creating web applications, the system comprising:
a controller generator that is adapted to provide a web application with a controller that receives requests for data from users and responds to the requests by obtaining requested data; and
a navigation manager generator that is adapted to provide a navigation manager that recalls a user request upon completion of a prerequisite.

2. The system set forth in claim 1, wherein the prerequisite comprises a form.

3. The system set forth in claim 1, wherein the prerequisite comprises a user login.

4. The system set forth in claim 1, wherein the prerequisite comprises an access rights verification.

5. The system set forth in claim 1, wherein the navigation manager generator is adapted to identify the prerequisite for the user request.

6. The system set forth in claim 1, wherein the navigation manager generator is adapted to store the user request upon identification of the prerequisite.

7. The system set forth in claim 1, comprising a model object and a view object separate from one another and separate from the controller, wherein the model object is adapted to provide an application state for the web application and the view object is adapted to provide a view presentation for the web application.

8. A method of creating web applications, the method comprising:
creating, with a processor-based device, a controller that receives requests for data from users and responds to the requests by obtaining requested data; and
providing a navigation manager to continue a user request after redirection to and completion of a prerequisite.

9. The method set forth in claim 8, comprising providing request tracking logic adapted to track the user request.

10. The method set forth in claim 8, comprising providing navigational rules for a portal name, a first path corresponding to initiation of the prerequisite, and a second path corresponding to completion of the prerequisite.

11. The method set forth in claim 10, comprising setting a first navigational rule to save an intended path corresponding to the user request if a navigational redirection is provided to the first path.

12. The method set forth in claim 11, comprises setting a second navigational rule to recall an intended path corresponding to the user request if a navigational redirection is provided to the second path.

13. The method set forth in claim 8, comprising providing request storage logic adapted to save the user request if subject to the prerequisite.

14. The method set forth in claim 8, comprising providing request recall logic adapted to recall the user request if the prerequisite is complete.

15. A system for creating web applications, the system comprising:
means for creating a controller that provides control functions for a web application, the controller being adapted to receive requests for data from users and respond to the requests by obtaining requested data; and
means for setting navigational rules for the web application to track an intended path for subsequent recall if redirected to an unintended path.

16. The system set forth in claim 15, wherein the means for setting navigational rules comprises means for storing the intended path.

17. The system set forth in claim 15, wherein the means for setting navigational rules comprises means for recalling the intended path.

18. A program for creating web applications, comprising:
a machine readable medium;
navigational control logic stored on the machine readable medium, the navigational control logic being adapted to provide a web application with the ability to save a user request upon identification of a prerequisite and to recall the user request upon completion of the prerequisite.

19. The program set forth in claim 18, comprising a controller generator stored on the machine readable medium, the controller generator being adapted to provide the web application with the ability to receive requests for data from users and respond to the requests by obtaining requested data.

20. The program set forth in claim 18, wherein the navigational control logic comprises navigational rules for a portal name, a first path corresponding to initiation of the prerequisite, and a second path corresponding to completion of the prerequisite.
